(19) United States
(12) Patent Application Publication
(10) Pub. No.: US 2022/0128373 A1
(43) Pub. Date: Apr. 28, 2022

(54) VEHICLE AND CONTROL METHOD THEREOF

(71) Applicants: HYUNDAI MOTOR COMPANY, SEOUL (KR); KIA CORPORATION, SEOUL (KR)

(72) Inventor: Seungshin LEE, Seoul (KR)

(73) Assignees: HYUNDAI MOTOR COMPANY, SEOUL (KR); KIA CORPORATION, SEOUL (KR)

(21) Appl. No.: 17/377,139

(22) Filed: Jul. 15, 2021

(30) Foreign Application Priority Data
Oct. 26, 2020 (KR) 10-2020-0139458

(51) Int. Cl. G01C 21/36; G08G 1/0968; G10L 15/22

(52) U.S. Cl. CPC G01C 21/36; G10L 2015/223; G10L 15/22; G08G 1/096877

(57) ABSTRACT

A vehicle including a microphone, a display device, a storage device, and a controller connected to the microphone, the display device, and the storage device are provided. The controller is configured to control the display device to output guide information including at least one voice command or a shortened voice command corresponding to the at least one voice command based on at least one of use history information of the voice commands stored in the storage device, operation information of at least one device of the vehicle, or state information of the vehicle, receive voice data including at least one of a first voice command or a first shortened voice command corresponding to the first voice command among the at least one voice command through the microphone, and control at least one device of the vehicle based on the received voice data.

### CROSS-REFERENCE TO RELATED APPLICATION

This application claims the priority to and the benefit of Korean Patent Application No. 10-2020-0139458, filed on Oct. 26, 2020, the disclosure of which is incorporated by reference herein in its entirety.

### TECHNICAL FIELD

The present disclosure relates to a vehicle and a control method thereof.

### BACKGROUND

With the development of technology, in order to help a user, for example, a driver's driving or for the driver's convenience, various functions such as navigation and Bluetooth communication are applied to vehicles, and voice recognition technology capable of controlling these functions is applied to vehicles.

Recently, as voice recognition technology of a vehicle, a technology for providing a voice command guide for voice recognition has been developed. A technology has been developed in which a vehicle randomly provides examples of previously stored voice commands when voice recognition is performed, so that the vehicle performs a function corresponding to the voice command when a user utters an example voice command.

The conventional vehicle voice recognition technology as described above has a disadvantage of providing a voice command without considering a user's situation and environment. For example, in the related art, a vehicle provides only previously stored voice commands to the user, thereby causing the user to use only limited voice commands.

### SUMMARY

It is an aspect of the disclosure to provide a vehicle capable of providing guides (or referred to as recommended help guides) of customized recommended voice commands to a user in consideration of the user's situation and environment, and a control method thereof.

For example, the vehicle may provide guides of the customized recommended voice commands in consideration of time, day of the week, vehicle location, vehicle type and/or vehicle state, and thus the user's convenience of using the voice recognition function may be improved.

It is an aspect of the disclosure to provide a vehicle capable of providing guides (or referred to as a shortcut) of shortened voice commands of numbers, alphabets and/or words corresponding to guides of customized recommended voice commands in consideration of the user's situation and environment, and a control method thereof.

For example, when the vehicle provides the guides of the shortened voice commands, a user may simply utter a shortened voice command so that the vehicle performs a corresponding function.

It is an aspect of the disclosure to provide a vehicle capable of registering voice commands frequently used by a user as a quick menu that may be provided to the user when the vehicle is started, when a voice recognition function of the vehicle is executed and/or when a predetermined condition is satisfied.

For example, as the vehicle registers and provides voice commands frequently used by a user as a quick menu, simplicity and accuracy of uttering voice commands of the user may be improved.

Additional aspects of the disclosure will be set forth in part in the description which follows and, in part, will be obvious from the description, or may be learned by practice of the disclosure.

In accordance with an aspect of the disclosure, a vehicle includes a microphone, a display device, a storage device, and a control device connected to the microphone, the display device, and the storage device, wherein the control device is configured to control the display device to output guide information including at least one voice command and a shortened voice command corresponding to the at least one voice command based on at least one of use history information of the voice commands stored in the storage device, operation information of at least one device of the vehicle, or state information of the vehicle, receive voice data including at least one of a first voice command or a first shortened voice command corresponding to the first voice command among the at least one voice command through the microphone, and control at least one device of the vehicle based on the received voice data.

The vehicle may further include a communication device, wherein the control device may be configured to transmit the voice data and the guide information to a server through the communication device in response to receiving the voice data, receive a voice recognition result of the voice data from the server through the communication device in response to the transmission of the voice data and the guide information, and control the at least one device of the vehicle based on the received voice recognition result.

The control device may be configured to identify the at least one voice command used more than a predetermined reference number among the voice commands based on the use history information of the voice commands stored in the storage device.

The control device may be configured to determine the at least one voice command from operation information of the at least one device of the vehicle based on whether a destination of a navigation device is set.

The control device may be configured to identify use history information of the navigation device, the location of the vehicle, the day of the week, and the time in response to a non-setting of the destination of the navigation device, and determine the at least one voice command corresponding to a setting of at least one recommended destination to the navigation device based on the use history information of the navigation device, the location of the vehicle, the day of the week, and the time.

The control device may be configured to identify use history information of the at least one device in response to a setting of the destination of the navigation device, and determine the at least one voice command corresponding to each of a time point of departure, running, and a time point of destination arrival of the vehicle based on the use history information of the at least one device.

The control device may be configured to control the display device to output corresponding guide information of at least one corresponding voice command at each of the time point of departure, the running, and the time point of destination arrival of the vehicle.

The state information of the vehicle comprises at least one of a remaining amount of fuel of the vehicle, a replacement cycle of consumables of the vehicle, or management information of the at least one device of the vehicle, and the control device may be configured to control the display device to output guide information of checking the state information of the vehicle based on the state information of the vehicle.

The vehicle may further include a communication device, wherein the control device may be configured to receive use information of a second voice command of at least one other vehicle through the communication device, and control the display device to output additional guide information indicating the second voice command and a second shortened voice command corresponding to the second voice command based on the use information of the second voice command.

In accordance with another aspect of the disclosure, a control method of a vehicle includes displaying guide information including at least one voice command and a shortened voice command corresponding to the at least one voice command on a display device of the vehicle based on at least one of use history information of previously stored voice commands, operation information of at least one device of the vehicle, or state information of the vehicle, receiving voice data including at least one of a first voice command of the at least one voice command or a first shortened voice command corresponding to the first voice command through a microphone of the vehicle, and controlling at least one device of the vehicle based on the received voice data.

The controlling the at least one device of the vehicle based on the received voice data may include transmitting the voice data and the guide information to a server through a communication device in response to receiving the voice data, receiving a voice recognition result of the voice data from the server through the communication device in response to the transmission of the voice data and the guide information, and controlling the at least one device of the vehicle based on the received voice recognition result.

The control method may further include identifying the at least one voice command used more than a predetermined reference number among the voice commands based on the use history information of the previously stored voice commands.

The control method may further include determining the at least one voice command from operation information of the at least one device of the vehicle based on whether a destination of a navigation device is set.

The determining the at least one voice command may include identifying use history information of the navigation device, the location of the vehicle, the day of the week, and the time in response to a non-setting of the destination of the navigation device, and determining the at least one voice command corresponding to a setting of at least one recommended destination to the navigation device based on the use history information of the navigation device, the location of the vehicle, the day of the week, and the time.

The determining the at least one voice command may include identifying use history information of the at least one device in response to a setting of the destination of the navigation device, and determining the at least one voice command corresponding to each of a time point of departure, running, and a time point of destination arrival of the vehicle based on the use history information of the at least one device.

The displaying the guide information on the display device of the vehicle may include displaying corresponding guide information of at least one corresponding voice command on the display device at each of the time point of departure, the running, and the time point of destination arrival of the vehicle.

The state information of the vehicle may include at least one of a remaining amount of fuel of the vehicle, a replacement cycle of consumables of the vehicle, or management information of the at least one device of the vehicle, and the displaying the guide information on the display device of the vehicle may include displaying guide information of checking the state information of the vehicle on the display device based on the state information of the vehicle.

The control method may further include receiving use information of a second voice command of at least one other vehicle, and the displaying the guide information on the display device of the vehicle may include displaying additional guide information indicating the second voice command and a second shortened voice command corresponding to the second voice command on the display device based on the use information of the second voice command.

### DRAWINGS

These and/or other aspects of the disclosure will become apparent and more readily appreciated from the following description of the forms, taken in conjunction with the accompanying drawings of which:

FIG. 1 is a block diagram of a system including a server and a vehicle in one form of the present disclosure;

FIGS. 2 and 3 are diagrams illustrating output screens of a display device of the vehicle in one form of the present disclosure;

FIG. 4 is a flowchart of an operation of the vehicle in one form of the present disclosure;

FIGS. 5A and 5B are diagrams for explaining the operation of the vehicle in one form of the present disclosure:

FIG. 6 is a flowchart of operations of the vehicle and the server in one form of the present disclosure; and

FIGS. 7A to 7C are diagrams for explaining the operations of the vehicle and the server in one form of the present disclosure.

### DETAILED DESCRIPTION

Like reference numerals refer to like elements throughout the specification. This specification does not describe all the elements of the forms, and duplicative contents between general contents or forms in the technical field of the disclosure will be omitted. The terms ‘part,’ ‘module,’ and ‘device’ used in this specification may be embodied as software or hardware, and it is also possible for a plurality of ‘parts,’ ‘modules,’ and ‘devices’ to be embodied as one component, or one ‘part,’ ‘module,’ and ‘device’ to include a plurality of components in some forms of the present disclosure.

Throughout the specification, when a part is referred to as being “connected” to another part, it includes not only a direct connection but also an indirect connection, and the indirect connection includes connecting through a wireless network.

Also, when it is described that a part “includes” an element, it means that the element may further include other elements, not excluding the other elements unless specifically stated otherwise.

The terms ‘first,’ ‘second,’ etc. are used to distinguish one element from another element, and the elements are not limited by the above-mentioned terms.

The singular forms “a,” “an,” and “the” include plural referents unless the context clearly dictates otherwise.

In each step, an identification numeral is used for convenience of explanation, the identification numeral does not describe the order of the steps, and each step may be performed differently from the order specified unless the context clearly states a particular order.

Hereinafter the disclosure will be described in detail with reference to the accompanying drawings.

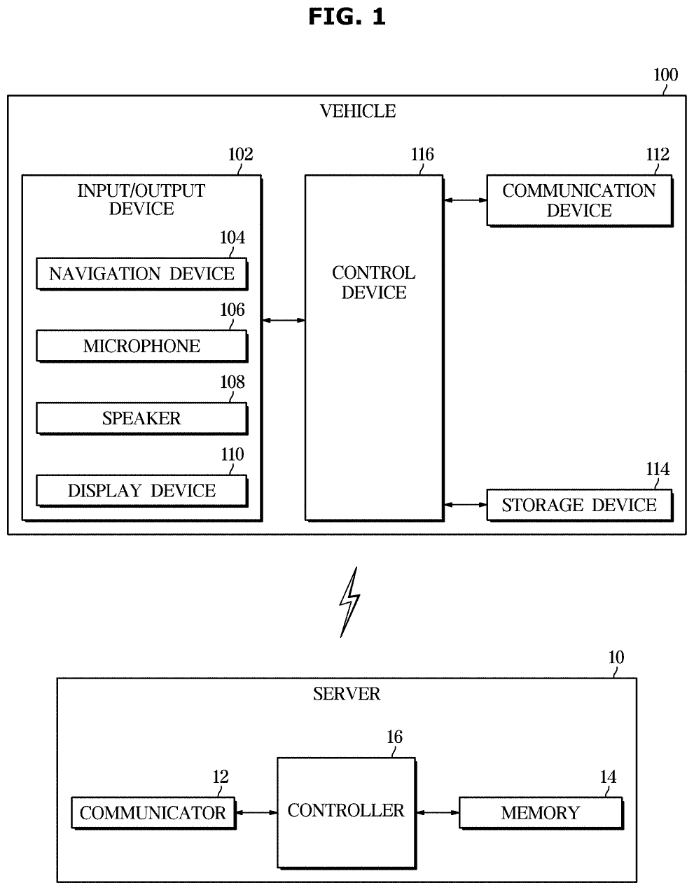

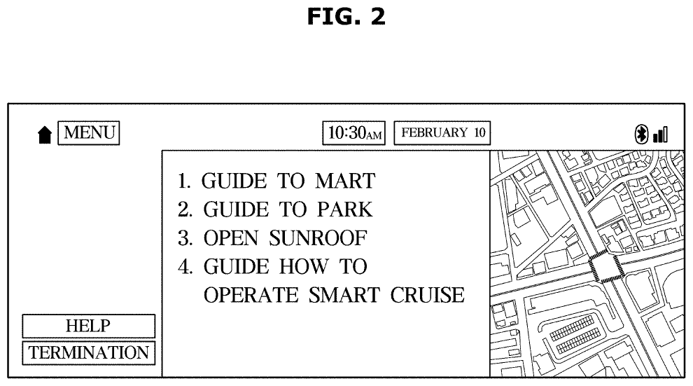

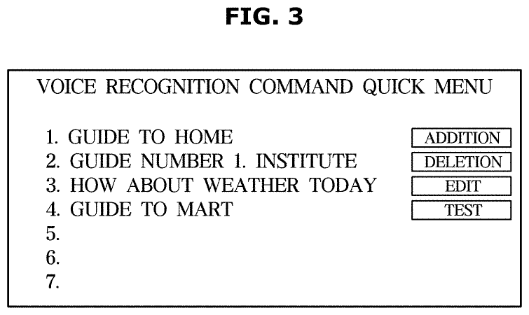

FIG. 1 is a block diagram of a system including a server and a vehicle in some forms of the present disclosure, and FIGS. 2 and 3 are diagrams illustrating output screens of a display device of the vehicle in some forms of the present disclosure.

Referring to FIG. 1, a vehicle 100 may include an input/output device 102, a communication device 112, a storage device 114, and/or a control device 116.

The input/output device 102 may include a navigation device 104, a microphone 106, a speaker 108, and/or a display device 110.

The navigation device 104 may output navigation information. The navigation information may include route information providing a route to a destination received from a driver of the vehicle 100.

The navigation device 104 may match location coordinates of the vehicle 100 identified through a satellite signal with a location on a map previously stored in the storage device 114 to identify vehicle location information and driving environment information, thereby generating route information. For example, the navigation device 104 may include a global positioning system (GPS) to receive a satellite signal propagating from a GPS satellite through the GPS. The satellite signal may include the location coordinates of the vehicle.

The microphone 106 may receive sound, for example, the voice of an occupant of the vehicle 100, and may convert the received sound into an electric signal.

The speaker 108 may convert an electrical signal into sound and output the sound.

The display device 110 may display, for example, various types of content (e.g., text, images, videos, icons, and/or symbols). The display device 110 may include a touch screen, and may receive, for example, a touch, gesture, proximity, or hovering input using a part of a user's body.

The navigation device 104 and the display device 110 may be included in an audio video navigation (AVN) device (not shown) of the vehicle 100. The AVN device may refer to a multimedia device in which audio, video, navigation, and/or telematics terminals are integrated into one. The AVN device may be provided on a center fascia of the vehicle 100, but is not limited thereto.

The communication device 112 may support establishing a wired and/or wireless communication channel between the vehicle 100 and an external device, for example, the server 10 and performing communication through the established communication channel, and may include a communication circuit. For example, the communication device 112 may include a wireless communication module (e.g., a cellular communication module, a Wi-Fi communication module, a short-range wireless communication module, a global navigation satellite system (GNSS) communication module), and/or a wired communication module, and may communicate with an external device using a corresponding communication module among them.

The communication device 112 may include a controller area network (CAN) communication circuit (or referred to as a CAN transceiver) for communicating with at least one component (the input/output device 102, storage device 114 and/or control device 116) of the vehicle 100 through a communication network for the vehicle 100, that is, transmits and receives signals, and a control circuit (or referred to as a control device) for controlling the operation of the CAN communication circuit.

The storage device 114 may store various data used by at least one component (the input/output device 102, communication device 112 and/or control device 116) of the vehicle 100, for example, input data or output data for a software program and commands related thereto. The storage device 110 may include a memory, for example, a volatile memory and/or a nonvolatile memory.

The control device 116 (or referred to as a control circuit or processor) may control at least one another component (e.g., hardware component (e.g., the input/output device 102, communication device 112 and/or storage device 114) or software component (software program)) of the vehicle 100, and may perform various data processing and operations. The control device 116 may include an electronic control unit (ECU) to control a power system of the vehicle 100. The control device 116 may include a processor and a memory.

The control device 116 may determine (or identify) guide information (or referred to as a guide list) of recommended voice commands customized to a user and provide the guide information to the user, based on information related to the vehicle 100 and/or the user (for example, the driving situation of the vehicle, the internal and external environment of the vehicle).

For example, the control device 116 may determine guide information based on the time, the day of the week, the location of the vehicle, the type of the vehicle, and/or the state of the vehicle, and may control the display device 110 to output the guide information.

The guide information may include one or more voice commands and a shortened voice command corresponding to each of the one or more voice commands.

The voice command may be at least one word or a sentence including a plurality of words. The shortened voice command may include numbers, alphabets, and/or words. For example, the shortened voice command may also be referred to as a shortcut.

The voice command and the shortened voice command may be commands capable of controlling at least one device (and/or function) of the vehicle. For example, at least one device of the vehicle may be various, such as the navigation device 104, the AVN device, an air conditioner, a heat wire seat, a sunroof, a media (audio), a window, a trunk, and/or Bluetooth.

Referring to FIG. 2, the control device 116 determines “Guide to the mart,” “Guide to the park,” “Open the sunroof,” and “Guide how to operate the smart cruise” as voice commands, and may determine the numbers 1, 2, 3, and 4 as shortened voice commands for each of the voice commands.

Accordingly, the control device 116 stores “1. Guide to the mart”, “2. Guide to the park,” “3. Open the sunroof,” and “4. Guide how to operate the smart cruise” as guide information, and may control the display device 110 so that the guide information is output as illustrated in FIG. 2.

The control device 116 may determine (or register) at least one voice command frequently used by the user as a quick menu, and store the determined voice command in the storage device 114.

The quick menu is provided through the display device 110 when the vehicle 100 is started, when the voice recognition function of the vehicle 100 is executed and/or when a predetermined condition is satisfied, and may include one or more voice commands and a shortened voice command corresponding to each of the one or more voice commands.

Referring to FIG. 3, the vehicle 100 may display one or more voice commands registered as a quick menu and a shortened voice command corresponding to each of the one or more voice commands on the display device 110.

The vehicle 100 may display menus including addition, deletion, edit and/or test when displaying the quick menu, and may reset the configuration of the quick menu based on user input (voice input through the microphone, touch input through the touch screen, and/or button press).

For example, the additional menu may be a menu for adding a voice command of a quick menu. The deletion menu may be a menu for deleting a voice command included in the quick menu. The edit menu may be a menu for changing a voice command and/or a shortened voice command included in the quick menu. The test menu is a menu for checking whether a quick menu is actually operable after being added and/or edited, and may include a function of providing guide information of an alternative voice command capable of performing a similar function when an operation is impossible.

For example, based on user input, when adding, deleting, editing and/or testing is selected, the control device 116 may perform control setting corresponding to a selected menu.

Referring to FIG. 3, the control device 116 may identify voice commands, such as “Guide to home,” “Guide the number 1. Institute,” “How about the weather today,” and “Guide to the mart,” as voice commands frequently used by the user. In addition, the control device 116 may determine, based on a designated priority (e.g., frequency of use and/or recent use history, etc.), the shortened voice command of “Guide to home” as the number 1, the shortened voice command of “Guide the number 1. Institute” as the number 2, the shortened voice command of “How about the weather today” as the number 3, and the shortened voice command of “Guide to the mart” as the number 4.

In this case, the control device 116 may determine the shortened voice commands and a voice command corresponding to each of the shortened voice commands as a quick menu (also referred to as voice recognition command quick menu) and may store the commands in the storage device 114. In addition, the control device 116 may control the display device 110 to display a screen including the quick menu as illustrated in FIG. 3.

The control device 116 may transmit voice data to the server 10 through the communication device 112 when receiving the voice data through the microphone 106. The control device 116 may transmit guide information together when transmitting the voice data to the server 10 through the communication device 112. For example, the voice data may include voice commands and/or shortened voice commands.

The control device 116 may receive a voice recognition result of the voice data from the server 10 through the communication device 112 in response to the transmission of voice data and guide information.

The control device 116 may control at least one device of the vehicle 100 based on the voice recognition result.

The server 10 may include a communicator 12, a memory 14 and/or a controller 16.

The communicator 12 (or referred to as a communication circuit) may support establishing a wired communication channel between the server 10 and an external device, for example, the vehicle 100 and performing communication through the established communication channel. For example, the communicator 12 may include a wireless communication module (e.g., a cellular communication module, a Wi-Fi communication module, a short-range wireless communication module, or a global navigation satellite system (GNSS) communication module) to communicate with an external device. The communicator 12 may include a communication circuit.

The memory 14 may store various data used by at least one component (the communicator 12 and/or controller 16) of the server 10, for example, input data or output data for a software program and commands related thereto. The memory 14 may include a volatile memory and/or a nonvolatile memory.

The controller 16 (or referred to as a control circuit or processor) may control at least one another component (e.g., hardware component (e.g., the communicator 12 and/or memory 14) or software component (software program)) of the connected server 10, and may perform various data processing and operations. The controller 16 may include a processor and a memory.

The controller 16 may receive voice data and guide information from the vehicle 100 through the communicator 12.

The controller 16 may identify whether a voice command and/or a shortened voice command included in the voice data of the vehicle 100 is included in the guide information, based on voice recognition of the voice data through the voice recognition technology.

When a voice command and/or a shortened voice command included in the voice data is included in the guide information, the controller 16 may update (or change) the guide information previously stored in the memory 14 and store the updated information.

For example, in a case where the previously stored guide information is “3. Turn on audio” while the received guide information is “3. Change the air conditioner to 21 degrees,” the controller 16 may change “3. Turn on audio” of the guide information previously stored in the memory 14 to “3. Change the air conditioner to 21 degrees” and store the information.

When a voice command and/or a shorten voice command included in the voice data is not included in the guide information, the controller 16 may recognize voice data based on the voice recognition technology and/or natural language recognition technology.

The controller 16 may transmit the voice recognition result to the vehicle 100 through the communicator 12.

In some forms of FIG. 1 described above, the speaker 108, the display device 110, the communication device 112, the audio of the AVN device, and/or the video of the AVN device, etc. may be referred to as output devices of the vehicle 100.

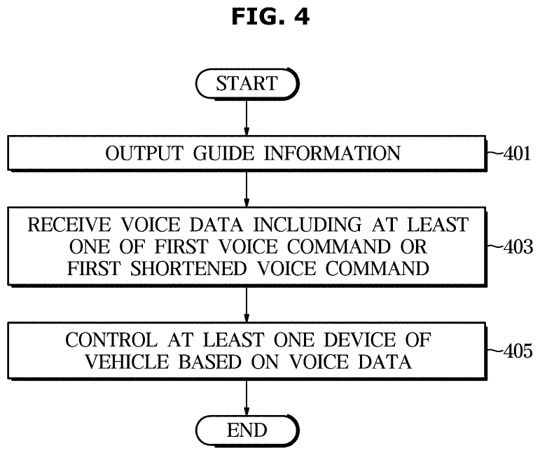

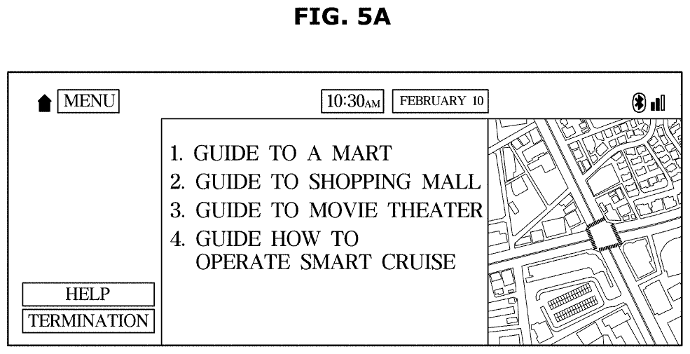

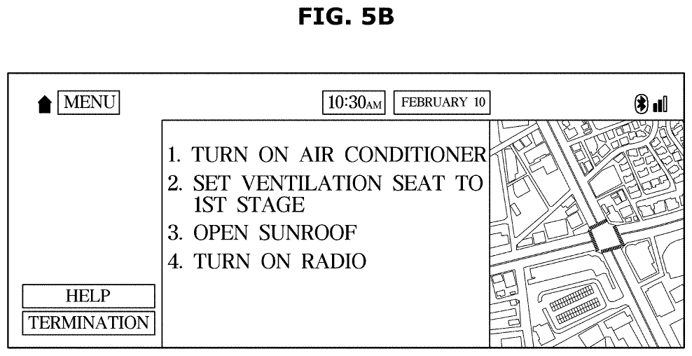

FIG. 4 is a flowchart of an operation of the vehicle 100 (the control device 116 of the vehicle 100) in some forms of the present disclosure, and FIGS. 5A and 5B are diagrams for explaining the operation of the vehicle 100 (the control device 116 of the vehicle 100) in some forms of the present disclosure.

The vehicle 100 may control the display device 110 to output guide information (401).

The vehicle 100 may control the display device 110 to output guide information based on at least one of use history information of voice commands stored in the storage device 114, operation information of at least one device of the vehicle 100, or state information of the vehicle 100.

The vehicle 100 may identify at least one voice command used more than a predetermined reference number among voice commands as a voice command to be included in the guide information based on the use history information of the voice commands stored in the storage device 114. The vehicle 100 may control the display device 110 to display guide information including at least one voice command identified as illustrated in FIG. 2.

The vehicle 100 may determine at least one voice command used more than the predetermined reference number among voice commands as a quick menu based on the use history information of the voice commands stored in the storage device 114. The vehicle 100 may control the display device 110 to display the quick menu as illustrated in FIG. 3.

The vehicle 100 may determine at least one voice command based on the operation information of the navigation device 104 among operation information of at least one device of the vehicle 100. The vehicle 100 may determine at least one voice command based on whether a destination of the navigation device 104 is set.

When the destination of the navigation device 104 is not set, the vehicle 100 may determine at least one voice command corresponding to the setting of at least one recommended destination so that the user may see the guide information displayed by the display device 110 and set the destination of the navigation device 104.

The vehicle 100 may determine guide information based on at least one voice command.

For example, the vehicle 100 determines a shortened voice command corresponding to each of one or more voice commands and may generate guide information including the one or more voice commands and a shortened voice command corresponding to each of the one or more voice commands. For example, the shortened voice command may be a number, and the vehicle 100 may determine a shortened voice command corresponding to each of the one or more voice commands based on a predetermined priority such as frequency of use and/or importance.

The vehicle 100 may control the display device 110 to display guide information including at least one voice command corresponding to the setting of at least one recommended destination, as illustrated in FIG. 5A.

For example, when the destination of the navigation device 104 is not set, the vehicle 100 may identify the use history information of the navigation device 104, the location of the vehicle 100, the day of the week, and the time. The vehicle 100 may determine at least one voice command corresponding to the setting of at least one recommended destination of the navigation device 104 based on the use history information of the navigation device 104, the location of the vehicle 100, the day of the week, and the time.

In addition, in consideration of the frequency of use of a voice command of a user of another vehicle, the vehicle 100 may determine at least one voice command corresponding to the setting of at least one recommended destination of the navigation device 104. For example, in addition to the above-described conditions, based on the frequency of use of a voice command of a user of another vehicle received from the server 10 through the communication device 112 (and/or the frequency of setting a specific destination of the navigation device 104), the vehicle 100 may determine at least one voice command corresponding to the setting of at least one recommended destination of the navigation device 104.

Referring to FIG. 5A, the vehicle 100 may provide the top three of guide information indicating voice commands for setting recommended destinations. For example, the vehicle 100 may display guide information such as “1. Guide to A Mart,” “2. Guide to a shopping mall,” and “3. Guide to a movie theater.” For example, the vehicle 100 may determine commands corresponding to the setting of two recommended destinations based on the use history information of the navigation device 104 of the user of the vehicle 100, that is, route setting information. In addition, the vehicle 100 may determine a command corresponding to the setting of one recommended destination based on the frequency of setting a specific destination by the navigation device 104 of a user of another vehicle.

For example, the vehicle 100 may determine “Guide to the company,” “Guide to the coffee shop” and “Guide to the hamburger shop” as voice commands based on route setting information such as a workplace (and/or school) of the user of the vehicle 100 and/or a user of another vehicle and may include these voice commands in guide commands to be provided on weekday mornings.

For example, the vehicle 100 may determine “Guide to nearby restaurants,” “Go home” and “Guide to Gangnam station” as voice commands based on route setting information such as a user's house (and/or a restaurant) and/or an appointment place, and may include these voice commands in guide commands to be provided on weekday afternoons.

For example, the vehicle 100 may determine “Guide to a mart, a department store, or a movie theater,” “Set a destination to a church,” and “Recommend a tourist destination” as voice commands, and may include these voice commands in guide commands to be provided over the weekend.

When the destination of the navigation device 104 is set, the vehicle 100 may identify use history information of at least one device of the vehicle 100, which is frequently manipulated by the user, at each of a time point of departure, running, and/or a time point of destination arrival of the vehicle 100. The vehicle 100 may determine at least one voice command corresponding to each of the time point of departure, running and/or the time point of destination arrival of the vehicle 100 in order to provide guide information of a voice command corresponding to control of a device that the user frequently manipulates at each of the time point of departure, running, and/or the time point of destination arrival of the vehicle 100.

The vehicle 100 may control to display guide information of a voice command corresponding to control of a device that the user frequently manipulates, as illustrated in FIG. 5B, at each of the time point of departure, running, and/or the time point of destination arrival of the vehicle 100.

For example, the vehicle 100 may identify a destination setting of the navigation device 104. The vehicle 100 may identify use history information of at least one device of the vehicle 100 in response to the destination setting of the navigation device 104. The vehicle 100 may determine at least one voice command corresponding to each of the time point of departure, running, and/or the time point of destination arrival of the vehicle 100 based on the use history information of the at least one device.

Referring to FIG. 5B, the vehicle 100 may display guide information, such as “1. Turn on the air conditioner,” “2. Set the ventilation seat to 1st stage,” “3. Open the sunroof” and “4. Turn on the radio,” at the time of departure of the vehicle 100.

The vehicle 100 may control the display device 110 to output guide information that enables checking of state information of the vehicle 100 based on the state information of the vehicle 100. The state information of the vehicle 100 may include a remaining amount of fuel of the vehicle 100, a replacement cycle of consumables of the vehicle 100, and/or management information of at least one device of the vehicle 100.

For example, when a warning sound appears on a dashboard of the vehicle 100 so that the user of the vehicle 100 may cope with an emergency situation, the vehicle 100 may output guide information of questions related to the warning sound (Q&A).

For example, when fuel in the vehicle 100 is insufficient, the vehicle 100 may control the display device 110 to output guide information for recommending oil prices of gas stations, brand of gas stations, current location of the vehicle 100, information around a route of the navigation device 104, information around a destination set in the navigation device 104, and/or information on gas stations frequently used by the vehicle 100. For example, when fuel in the vehicle 100 is insufficient, the vehicle 100 may output guide information such as “Guide to a nearby inexpensive gas station,” “Guide to a gas station on the route”, and/or “Guide to a gas station near the destination.”

For example, when the replacement cycle of consumables of the vehicle 100 approaches, the vehicle 100 may output guide information on a question related to replacement of consumables. For example, the vehicle 100 may output guide information such as “Tell the engine oil replacement period” and/or “Tell how to check the wiper” based on the consumable replacement period of the vehicle 100.

The vehicle 100 may receive voice data including at least one of a first voice command or a first shortened voice command corresponding to the first voice command through the microphone 106 (403).

The first voice command may be a command included in at least one voice command included in the guide information.

The vehicle 100 may control at least one device of the vehicle 100 based on the received voice data (405).

When the user of the vehicle 100 utters “Execute voice guide the number 1” and “Voice help No. 3,” the vehicle 100 may control corresponding devices according to the recognized order. In this case, the numbers 1 and 3 may be shorthand commands, and the display device 110 of the vehicle 100 may be outputting guide information including the numbers 1 and 3.

When the user simply utters only the number, for example, when “The number 1” is uttered, the vehicle 100 may control a device corresponding to the “The number 1.”

In addition to some forms of the present disclosure, the vehicle 100 may receive a result of voice recognition of voice data based on communication with the server 10, and may control at least one device of the vehicle 100 based on the received voice recognition result.

For example, the vehicle 100 may transmit voice data and guide information to the server 10 through the communication device 112 in response to receiving the voice data. The vehicle 100 may receive a voice recognition result of the voice data from the server 10 through the communication device 112 in response to the transmission of voice data and guide information. The vehicle 100 may control at least one device of the vehicle 100 based on the received voice recognition result.

Further, in addition to the above-described form of the present disclosure, when the display device 110 outputs the guide information, the speaker 108 may also output the guide information as a voice.

In the above-described form of the present disclosure, the vehicle 100 may provide guide information indicating a customized recommended voice command suitable for the user's environment. For example, although the same voice command as “Help the number 1” is not stored the storage device 114 of the vehicle 100, in a case where the number 1 is stored as a shortened voice command, when the user sees the guide information displayed on the display device 110 and utters the same number 1 as “Help the number 1,” the vehicle 100 may control at least one device based on the number 1.

Further, in the above-described form of the present disclosure, the vehicle 100 may analyze the use information of the voice recognition function of the user of the vehicle 100, and based on this analysis, may register voice commands frequently used by the user as a quick menu and store the voice commands in the storage device 114. When the user checks the screen of the quick menu and utters, for example, “Execute voice quick menu the number 1,” the vehicle 100 may receive voice data of the user through the microphone 106. The vehicle 100 may control at least one device corresponding to the shortened voice command of the number 1 by identifying the number 1, which is the shortened voice command included in the voice data.

Further, in the above-described form of the present disclosure, when the destination of the navigation device 104 is not set and/or the destination is set, the vehicle 100 may provide guide information as illustrated in Table 1 below at each of the time point of departure, running, and/or the time point of destination arrival of the vehicle 100.

TABLE 1

| Time Point | |
|---|---|
| of Operation | Guide Information |
| Time point | [Destination setting] Go home; [Control command] Control |
| of departure | commands for the air conditioning, heat wires, windows, a trunk, etc. |
| | [Media] Play FM radio, Play music |
| | [Search of setting] Set up Bluetooth |
| When | [Route guidance] Voice guides for route re-search, quick directions, |
| driving | adding a stopover, guidance at nearby gas stations, etc. |
| | Help recommendation [Information] Voice guide recommendation |
| | related to information such as weather, horoscope, stock price, and |
| | sports |
| | [Media] Play FM radio, Play music |
| | [Manual Q&A] What is the smart cruise control, What is the sport |
| | mode, Tell how to change the comfort mode |
| | [Check of consumables] Tell the tire replacement cycle |
| | [Phone/Message] Call Hong Gil-dong |
| | [Car to Home] Turn off the boiler, Car to home outgoing mode |
| Time point | [Guide to the parking lot] Finding a nearby parking lot, [Parking |
| of arrival | assistance] When the vehicle is equipped with a parking assist |
| | function, it is recommended to use a voice guide such as a parking |
| | assist function guidance Q&A |
| | [Function termination guide] Turn off the radio, Close the windows/a |
| | sunroof, Turn off the air conditioner/ the heat wires |
| | [On arrival at the gas station] Open the oil filling port |
| | [Control command] Open the trunk |

Further, in the above-described form of the present disclosure, the vehicle 100 may provide guide information as illustrated in Table 2 below based on other situations.

TABLE 2

| Other | |
|---|---|
| Situations | Guide Information |
| When drowsy Media | recommendation, Control command recommendation such |
| driving | as opening the windows/the sunroof |
| When it comes | Media recommendation (Radio channel recommendation based |
| time to listen to | on use history and/or radio channel recommendation based on |
| the radio often | listening rate) |
| When a new | What is the smart cruise control (Recommendation of useful |
| function of the | functions in the current vehicle type and manual Q&A with high |
| vehicle is not | frequency of use by customers of the same vehicle type) |
| used | |
| When the | Search for convenience feature settings, Settings search |
| setting function | Bluetooth |
| is not used | |
| In the event of | How to run the SOS service |
| a car accident | |
| When boarding | Open the passenger seat window, Turn on the rear seat heat wire |
| a passenger | |
| seat or a rear | |
| seat | |
| In the event of | Re-search the route, Share the location of my car, Send SNS |
| traffic | messenger to Hong Gil-dong that it's late (Voice guide |
| congestion | recommendation such as alternative route guidance, location |
| | notification, phone call, message, and SNS messenger) |
| When driving | What is the sand mode, What is the smart cruise control (Voice |
| on | guide recommendation of the driving mode of the vehicle based |
| highways/rough | on location and the driving assistance function Q&A) |
| roads | |
| In case of | Voice guide recommendation of weather related Q&A |
| special weather | |
| conditions such | |
| as rainy | |
| weather, | |
| typhoon, snow, | |
| and days with | |
| high | |
| concentration | |
| of fine dust | |
| When a | (When the radio screen is executed) Recommendations related to |
| designated | the radio channels, (When the setting screen is executed) Voice |
| screen in the | guide recommendation related to the setting search |
| foreground of | |
| the display | |
| device is | |
| executed | |

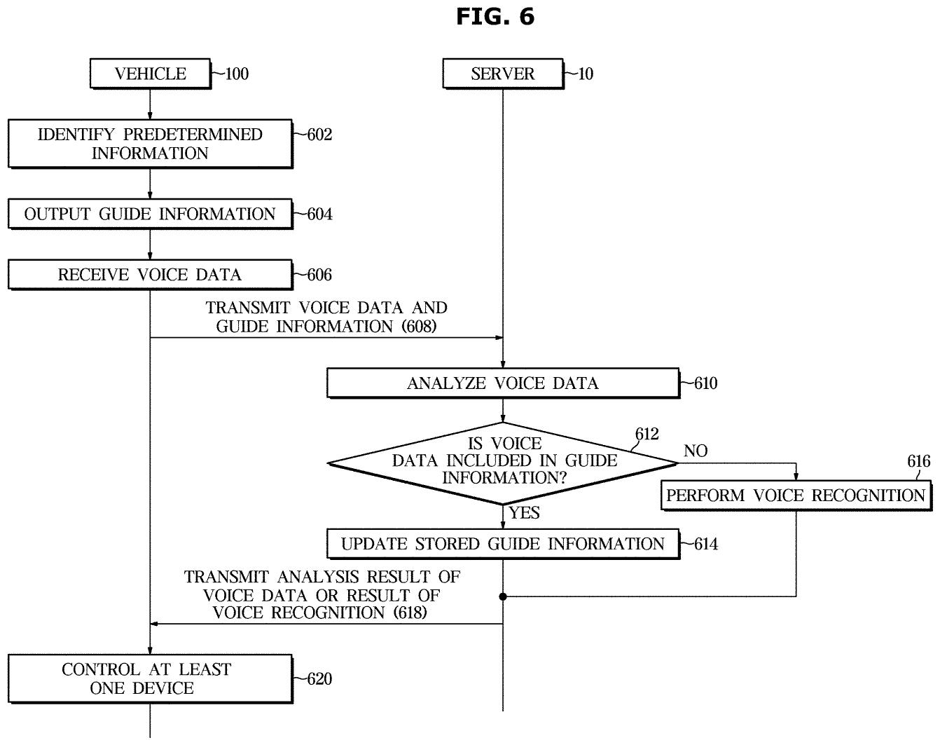

FIG. 6 is a flowchart of operations of the vehicle 100 (or the control device 116 of the vehicle 100) and the server 10 (or the controller 16 of the server 10) in some forms of the present disclosure.

The vehicle 100 may identify predetermined information (602).

The predetermined information may include use history information of voice commands previously stored in the storage device 114, operation information of at least one device of the vehicle 100, state information of the vehicle 100, information related to other vehicles (use information of voice commands, destination setting information of the navigation device, etc.), and/or external environment information (weather, road conditions, etc.).

The vehicle 100 may control the display device 110 to output guide information based on the predetermined information (604).

The guide information may include one or more voice commands and/or a shortened voice command of each of the one or more voice commands.

The vehicle 100 may control the display device 110 to output the guide information by determining one or more voice commands and/or a shortened voice command of each of the one or more voice commands based on the predetermined information.

The vehicle 100 may receive voice data through the microphone 106 (606).

The voice data may include one or more voice commands and/or a shortened voice command of each of the one or more voice commands.

The vehicle 100 may transmit the voice data and the guide information to the server 10 through the communication device 112 (608).

The server 10 may analyze the received voice data (610).

The server 10 may receive the voice data and the guide information through the communicator 12 and may analyze the received voice data.

The server 10 may identify whether the received voice data is included in the guide information (612).

The server 10 may identify whether the received voice data includes voice data and/or shortened voice commands included in the guide information.

The server 10 may perform operation 614 when the received voice data is included in the guide information, and otherwise perform operation 616.

The server 10 may update the stored guide information (614).

The server 10 may identify a voice command corresponding to the received voice data from the received guide information and may update (or change) at least a part of the entire guide information stored in the server 10 based on the above.

The server 10 may perform voice recognition of voice data based on voice recognition technology and/or natural language recognition technology (616).

The server 10 may transmit an analysis result of voice data or a result of voice recognition to the vehicle 100 through the communicator 12 (618).

The vehicle 100 may control at least one device of the vehicle 100 based on the analysis result of voice data or the result of voice recognition (620).

The vehicle 100 may receive the analysis result of voice data or the result of voice recognition through the communication device 112 and may control at least one device of the vehicle 100 based on the analysis result of voice data or the result of voice recognition.

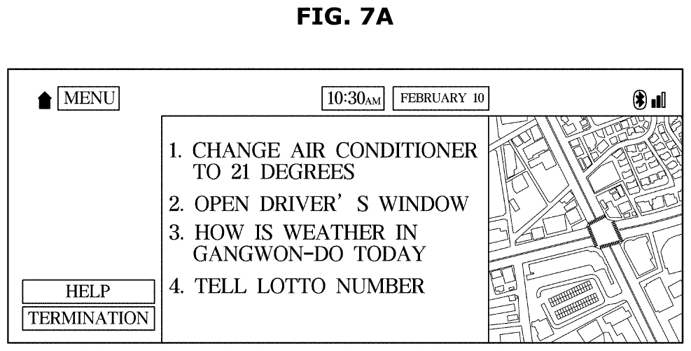

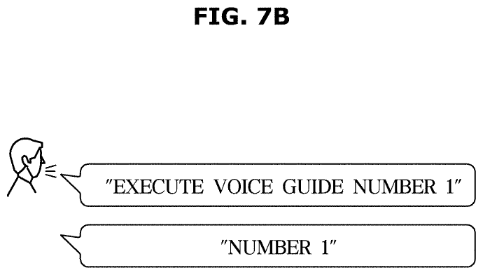

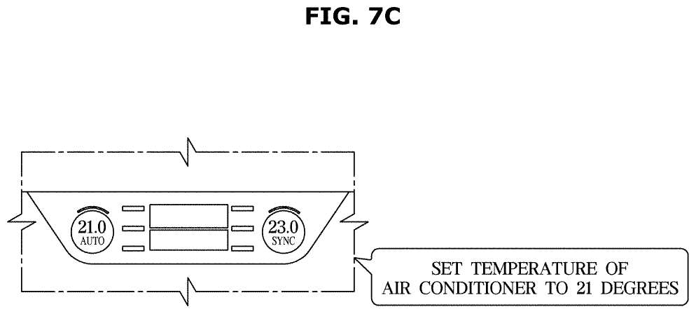

FIGS. 7A to 7C are diagrams for explaining the operations of the vehicle 100 (or the control device 116 of the vehicle 100) and the server 10 (or the controller 16 of the server 10) in some forms of the present disclosure.

Referring to FIG. 7A, the guide information may include “1. Change the air conditioner to 21 degrees,” “2. Open the driver's window”, “3. How is the weather in Florida today,” and “4. Tell the lotto number.”

Referring to FIG. 7B, the user may utter “Execute voice guide the number 1” or “The number 1,” and the vehicle 100 may receive the voice data of the user. The vehicle 100 may transmit the received voice data and the guide information (the entire list of guide information) of FIG. 7A to the server 10.

The server 10 may receive the voice data and voice guide information of “Execute voice guide the number 1” or “The number 1,” and may identify that the voice recognition result and intention of “Execute voice guide the number 1” is a voice guide based on the voice data and the voice guide information.

For example, the server 10 may identify the command the number 1 by identifying guide information corresponding to the voice data from the voice guide information.

The server 10 may convert the command the number 1 into a corresponding voice command of “Change the air conditioner to 21 degrees,” and may identify that the intention of this voice command is that the air temperature slot is 21. The server 10 may transmit a result to the vehicle 100 so that the vehicle 100 may control the air conditioner based on the converted voice command and the intention of the voice command.

The vehicle 100 may control the temperature of the air conditioner based on the result received from the server 10 and may output a voice such as “Set the temperature of the air conditioner to 21 degrees” to the speaker 108 as illustrated in FIG. 7C.

Herein, some forms of the present disclosure may be implemented in the form of a recording medium storing commands executable by a computer. The commands may be stored in the form of program code, and when executed by a processor, a program module may be created to perform the operations of the disclosed forms. The recording medium may be implemented as a computer-readable recording medium.

The computer-readable recording medium includes various kinds of recording media in which commands which may be decrypted by a computer are stored. For example, there may be a ROM (Read Only Memory), a RAM (Random Access Memory), a magnetic tape, a magnetic disk, a flash memory, an optical data storage device, and the like.

As is apparent from the above, because a vehicle and a control method thereof in some forms of the present disclosure can provide customized recommended voice guides (or referred to as recommended help guides) to a user in consideration of the user's situation and environment, the user can utter a voice command such that a vehicle control function suitable for his or her situation is executed.

Further, the vehicle and the control method thereof in some forms of the present disclosure can provide a learning effect that allows a user who is not familiar with voice commands to use various voice commands suitable for the user's situation.

Further, the vehicle and the control method thereof in some forms of the present disclosure can increase usability of a new function by providing a voice guide (or referred to as a Q&A guide) when the new function is equipped with the vehicle.

Further, the vehicle and the control method thereof in some forms of the present disclosure can allow the user to conveniently perform a voice recognition function through the registration of frequently and repeatedly used voice commands.

Further, the vehicle and the control method thereof in some forms of the present disclosure can improve a recognition rate of voice recognition of the vehicle by supporting various types of voice commands, for example, shortened voice commands such as numbers, alphabets, and/or words.

For example, when a user whose voice recognition is difficult due to dialect, intonation, etc. uses a shortened voice command, a success rate of the voice recognition of the user can increase, and thus convenience of voice recognition use of the user can be improved.

The forms disclosed with reference to the accompanying drawings have been described above. It will be understood by those skilled in the art that various changes in form and details may be made therein without departing from the spirit and scope of the disclosure as defined by the appended claims. The disclosed forms are illustrative and should not be construed as limiting.

What is claimed is:

1. A vehicle comprising:
a microphone;
a display device;
a storage device; and
a controller connected to the microphone, the display device, and the storage device,
wherein the controller is configured to:
control the display device to output guide information including at least one voice command or a shortened voice command corresponding to the at least one voice command based on at least one of use history information of the voice commands stored in the storage device, operation information of at least one device of the vehicle, or state information of the vehicle;
receive voice data including at least one of a first voice command or a first shortened voice command corresponding to the first voice command among the at least one voice command through the microphone; and
control at least one device of the vehicle based on the received voice data.

2. The vehicle according to claim 1, further comprising:
a communication device,
wherein the controller is configured to:
transmit the voice data and the guide information to a server through the communication device in response to receiving the voice data;
receive a voice recognition result of the voice data from the server through the communication device in response to the transmission of the voice data and the guide information; and
control the at least one device of the vehicle based on the received voice recognition result.

3. The vehicle according to claim 1, wherein the controller is configured to:
identify the at least one voice command used more than a predetermined reference number among the voice commands based on the use history information.

4. The vehicle according to claim 1, wherein the controller is configured to:
determine the at least one voice command from operation information of the at least one device of the vehicle based on whether a destination of a navigation device is set.

5. The vehicle according to claim 4, wherein the controller is configured to:
identify use history information of the navigation device, the location of the vehicle, the day of the week, and the time in response to a non-setting of the destination of the navigation device; and
determine the at least one voice command corresponding to a setting of at least one recommended destination to the navigation device based on the use history information of the navigation device, the location of the vehicle, the day of the week, and the time.

6. The vehicle according to claim 4, wherein the controller is configured to:
identify use history information of the at least one device in response to a setting of the destination of the navigation device; and
determine the at least one voice command corresponding to each of a time point of departure, running, and a time point of destination arrival of the vehicle based on the use history information of the at least one device.

7. The vehicle according to claim 6, wherein the controller is configured to:
control the display device to output corresponding guide information of at least one corresponding voice command at each of the time point of departure, the running, and the time point of destination arrival of the vehicle.

8. The vehicle according to claim 1, wherein:
the state information of the vehicle comprises at least one of a remaining amount of fuel of the vehicle, a replacement cycle of consumables of the vehicle, or management information of the at least one device of the vehicle, and
the controller is configured to control the display device to output guide information of checking the state information of the vehicle based on the state information of the vehicle.

9. The vehicle according to claim 1, further comprising
a communication device,
wherein the control device is configured to:
receive use information of a second voice command of at least one other vehicle through the communication device; and
control the display device to output additional guide information indicating the second voice command and a second shortened voice command corresponding to the second voice command based on the use information of the second voice command.

10. A control method of a vehicle comprising:
displaying guide information including at least one voice command or a shortened voice command corresponding to the at least one voice command on a display device of the vehicle based on at least one of use history information of previously stored voice commands, operation information of at least one device of the vehicle, or state information of the vehicle;
receiving voice data including at least one of a first voice command of the at least one voice command or a first shortened voice command corresponding to the first voice command through a microphone of the vehicle; and
controlling at least one device of the vehicle based on the received voice data.

11. The control method according to claim 10, wherein controlling the at least one device of the vehicle based on the received voice data comprises:
transmitting the voice data and the guide information to a server through a communication device in response to receiving the voice data;
receiving, from the server, a voice recognition result of the voice data through the communication device in response to the transmission of the voice data and the guide information; and
controlling the at least one device of the vehicle based on the received voice recognition result.

12. The control method according to claim 10, further comprising:
identifying the at least one voice command used more than a predetermined reference number among the voice commands based on the use history information.

13. The control method according to claim 10, further comprising:
determining the at least one voice command from operation information of the at least one device of the vehicle based on whether a destination of a navigation device is set.

14. The control method according to claim 13, wherein determining the at least one voice command comprises:
identifying use history information of the navigation device, the location of the vehicle, the day of the week, and the time in response to a non-setting of the destination of the navigation device; and
determining the at least one voice command corresponding to a setting of at least one recommended destination to the navigation device based on the use history information of the navigation device, the location of the vehicle, the day of the week, and the time.

15. The control method according to claim 13, wherein determining the at least one voice command comprises:
identifying use history information of the at least one device in response to a setting of the destination of the navigation device; and
determining the at least one voice command corresponding to each of a time point of departure, running, and a time point of destination arrival of the vehicle based on the use history information of the at least one device.

16. The control method according to claim 15, wherein displaying the guide information on the display device of the vehicle comprises:
displaying, on the display device, corresponding guide information of at least one corresponding voice command at each of the time point of departure, the running, and the time point of destination arrival of the vehicle.

17. The control method according to claim 10, wherein displaying the guide information on the display device of the vehicle comprises:
displaying, on the display device, guide information of checking the state information of the vehicle based on the state information of the vehicle, wherein the state information of the vehicle comprises at least one of a remaining amount of fuel of the vehicle, a replacement cycle of consumables of the vehicle, or management information of the at least one device of the vehicle.

18. The control method according to claim 10, further comprising:
receiving use information of a second voice command of at least one other vehicle; and
displaying, on the display device, additional guide information indicating the second voice command and a second shortened voice command corresponding to the second voice command based on the use information of the second voice command.
